(19) United States
(12) Patent Application Publication
(10) Pub. No.: US 2022/0162452 A1
(43) Pub. Date: May 26, 2022

(54) Functionalized Silicon Oxycarbide Additives And Pigments, And Methods Of Make The Materials

(71) Applicant: Melior Innovations, Inc., Houston, TX (US)

(72) Inventors: Wen Liao, Clifton Park, NY (US); Connor Kilgallen, Amsterdam, NY (US); Isabel Burlingham, Troy, NY (US); David Bening, Columbus, OH (US); Paul Lindquest, Columbus, OH (US)

(73) Assignee: Melior Innovations, Inc., Houston, TX (US)

(21) Appl. No.: 17/531,506

(22) Filed: Nov. 19, 2021

Related U.S. Application Data
(60) Provisional application No. 63/116,894, filed on Nov. 22, 2020.

(51) Int. Cl. C09C 3/12; C09C 1/00; C08K 9/06; C09D 7/62

(52) U.S. Cl. CPC C09C 3/12; C09D 7/62; C08K 9/06; C09C 1/0081

(57) ABSTRACT

A material may include a pigment and one or more silicon oxycarbides (SiOC) disposed in the black ceramic pigment, wherein a surface of the pigment is free of one or more silanols (Si—OH) bonds.

### BACKGROUND

The present disclosures relate to black materials and formulations utilizing these materials. Generally, the present disclosures relate to: ceramic materials having blackness, black color, and which are black; starting compositions for these ceramic materials, and methods of making these ceramic materials; and formulations, compositions, materials and devices that utilize or have these ceramic materials. In particular, embodiments of the present disclosures include: black ceramics having silicon, oxygen and carbon, and methods of making these ceramics; and devices, structures and apparatus that have or utilize these formulations, plastics, paints, inks, coatings and adhesives containing these black ceramics.

As used herein, unless stated otherwise, the terms “color,” “colors” “coloring” and similar such terms are be given their broadest possible meaning and would include, among other things, the appearance of the object or material, the color imparted to an object or material by an additive, methods of changing, modifying or affecting color, the reflected refracted and transmitted wavelength(s) of light detected or observed from an object or material, the reflected refracted and transmitted spectrum(s) of light detected or observed from an object or material, all colors, e.g. white, grey, black, red, violet, amber, almond, orange, aquamarine, tan, forest green, etc., primary colors, secondary colors, and all variations between, and the characteristic of light by which any two structure free fields of view of the same size and shape can be distinguish between.

As used herein, unless stated otherwise, the terms “black”, “blackness”, and similar such terms, are to be given there broadest possible meanings, and would include among other things, the appearance of an object, color, or material: that is substantially the darkest color owing to the absence, or essential absence of, or absorption, or essential abortion of light; where the reflected refracted and transmitted spectrum(s) of light detected or observed from an object or material has no, substantially no, and essentially no light in the visible wavelengths; the colors that are considered generally black in any color space characterization scheme, including the colors that are considered generally black in L a b color space, the colors that are considered generally black in the Hunter color space, the colors that are considered generally black in the CIE color space, and the colors that are considered generally black in the CIELAB color space; any color, or object or material, that matches or substantially matches any Pantone® color that is referred to as black, including PMS 433, Black 3, Black 4, Black 5, Black 6, Black 7, Black 2 2×, Black 3 2×, Black 4 2×, Black 5 2×, Black 6 2×, Black 7 2×, 412, 419, 426, and 423; values on a Tri-stimulus Colorimeter of X=from about 0.05 to about 3.0; Y=from about 0.05 to about 3.0, and Z=from about 0.05 to about 3.0; in non glossy formulations; a CIE L a b of L=less than about 40, less than about 20, less than about 10, less than about 1, and about zero, of “a”=of any value; of “b”=of any value; and a CIE L a b of L=less than 50 and b=less than 1.0; an L value less than 30, a “b” value less than 0.5 (including negative values) and an “a” value less than 2 (including negative values); having a jetness value of about 200 M_{y} and greater, about 250 M_{y} and greater, 300 M_{y} and greater, and greater; having an L=40 or less and a My of greater than about 250; having an L=40 or less and a My of greater than about 300; having a dM value of 10; having a dM value of −15; and combinations and variations of these.

As used herein, unless stated otherwise, the term “gloss” is to be given its broadest possible meaning, and would include the appearance from specular reflection. Generally the reflection at the specular angle is the greatest amount of light reflected for any specific angle. In general, glossy surfaces appear darker and more chromatic, while matte surfaces appear lighter and less chromatic.

As used herein, unless stated otherwise, the term “Jetness” is to be given its broadest possible meaning, and would include among other things, a Color independent blackness value as measured by M_{y} (which may also be called the “blackness value”), or Mc, the color dependent blackness value, and M_{y} and Mc values obtained from following DIN 55979 (the entire disclosure of which is incorporated herein by reference).

As used herein, unless stated otherwise, the term “undertone,” “hue” and similar such terms are to be given their broadest possible meaning, and would include among other things.

As used herein, unless stated otherwise, the terms “visual light,” “visual light source,” “visual spectrum” and similar such terms refers to light having a wavelength that is visible, e.g., perceptible, to the human eye, and includes light generally in the wave length of about 390 nm to about 770 nm.

As used herein, unless stated otherwise, the term “paint” is to be given its broadest possible meaning, and would include among other things, a liquid composition that after application as a thin layer to a substrate upon drying forms a thin film on that substrate, and includes all types of paints such as oil, acrylic, latex, enamels, varnish, water reducible, alkyds, epoxy, polyester-epoxy, acrylic-epoxy, polyamide-epoxy, urethane-modified alkyds, and acrylic-urethane.

As used herein, unless stated otherwise, the term “plastic” is to be given its broadest possible meaning, and would include among other things, synthetic or semi-synthetic organic polymeric materials that are capable of being molded or shaped, thermosetting, thermoforming, thermoplastic, orientable, biaxially orientable, polyolefins, polyamide, engineering plastics, textile adhesives coatings (TAC), plastic foams, styrenic alloys, acrylonitrile butadiene styrene (ABS), polyurethanes, polystyrenes, acrylics, polycarbonates (PC), epoxies, polyesters, nylon, polyethylene, high density polyethylene (HDPE), very low density polyethylene (VLDPE), low density polyethylene (LDPE), polypropylene (PP), polyvinyl chloride (PVC), polyethylene terephthalate (PET), polybutylene terephthalate (PBT), poly ether ethyl ketone (PEEK), polyether sulfone (PES), bis maleimide, and viscose (cellulose acetate).

As used herein, unless stated otherwise, the term “ink” is to be given its broadest possible meaning, and would include among other things, a colored liquid for marking or writing, toner (solid, powder, liquid, etc.) for printers and copiers, and colored solids that are used for marking materials, pigment ink, dye ink, tattoo ink, pastes, water-based, oil-based, rubber-based, and acrylic-based.

As used herein, unless stated otherwise, the term “nail polish” and similar such terms, are to be given its broadest term, and would include all types of materials, coatings and paints that can be applied to, or form a film, e.g., a thin film, on the surface of a nail, including natural human nails, synthetic “fake” nails, and animal nails.

As used herein, unless stated otherwise, the term “adhesive” is to be given its broadest possible meaning, and would include among other things, substances (e.g., liquids, solids, plastics, etc.) that are applied to the surface of materials to hold them together, a substance that when applied to a surface of a material imparts tack or stickiness to that surface, and includes all types of adhesives, such as naturally occurring, synthetic, glues, cements, paste, mucilage, rigid, semi-rigid, flexible, epoxy, urethane, methacrylate, instant adhesives, super glue, permanent, removable, and expanding.

As used herein, unless stated otherwise, the term “coating” is to be given its broadest possible meaning, and would include among other things, the act of applying a thin layer to a substrate, any material that is applied as a layer, film, or thin covering (partial or total) to a surface of a substrate, and includes inks, paints, and adhesives, powder coatings, foam coatings, liquid coatings, and includes the thin layer that is formed on the substrate, e.g. a coating.

As used herein, unless stated otherwise, the term “sparkle” is to be given its broadest possible meaning, and would include among other things, multi angle reflections simultaneously imparted from the surface facets.

As used herein, unless stated otherwise, room temperature is 25° C. And, standard temperature and pressure is 25° C. and 1 atmosphere.

Generally, the term “about” as used herein unless specified otherwise is meant to encompass a variance or range of ±10%, the experimental or instrument error associated with obtaining the stated value, and preferably the larger of these.

### SUMMARY

There has been a long-standing and unfulfilled need for, improved pigments and additives for plastics, paints, inks, coatings and adhesives, as well as a continued need for improved formulations for these coatings and materials. The present disclosures, among other things, solve these needs by providing the compositions of matter, materials, articles of manufacture, devices and processes taught, disclosed and claimed herein.

There is provided a method for making a black ceramic pigment aggregate, the method including: pyrolizing a polymer derived ceramic to form black polymer derived ceramic bulk material, reducing the size of the polymer derived ceramic bulk material to form primary pigment particles having a particle size D₅₀ of from about 1 μm to about 0.1 μm, the primary pigment particles including from about 30 weight % to about 60 weight % silicon, from about 5 weight % to about 40 weight % oxygen, and from about 3 weight % to about 35 weight % carbon.

There is further provided the methods that have one or more of the following features: wherein the primary pigment particles are formed into agglomerate particles; wherein the agglomerate particles have a particle size D₅₀ of at least about 10 μm; wherein the act of reducing the size of the particles includes using equipment selected from the group consisting of a ball mill, an attrition mill, a rotor stator mill, a hammer mill, a jet-mill, a roller mill, a bead mill, a media mill, a grinder, a homogenizer, and a two-plate mill; wherein reducing includes using equipment selected from the group consisting of a ball mill, a rotor stator mill, a hammer mill, a jet-mill, a roller mill, a bead mill, a homogenizer, and a two-plate mill; wherein spray drying forms the agglomerate; wherein a binder is used to, in part, form the agglomerate; wherein the binder is selected from the group consisting of dispersants, surfactants, soaps, copolymers, starches, natural and synthetic polymers and saccharides, lipids, fatty acids, petroleum-derived polymers and oligomers; wherein the binder is selected from the group consisting of sodium alginate, corn starch, starch, fructoses, saccharides carrageenan and water-soluble polymers; wherein about 0.01% to about 5% by weight binder is used; and wherein about 0.1% to about 2% by weight binder is used.

Still further there is provided a method of making a coating including: combining an agglomerated black polysilocarb derived pigment with a primary formation material, mixing the combination whereby the agglomerated pigment is broken down into primary pigment particles; and wherein the primary pigment particles are dispersed throughout the primary formation material.

There is further provided the methods that have one or more of the following features: wherein the primary pigment particles comprise from about 30 weight % to about 60 weight % silicon, from about 5 weight % to about 40 weight % oxygen, and from about 3 weight % to about 35 weight % carbon; wherein the primary formation material is a resin; wherein the resin is selected from the group consistent of oil, acrylic, latex, enamel, varnish, water reducible, alkyd, epoxy, polyester-epoxy, acrylic-epoxy, polyimide-epoxy, urethane-modified alkyd, and acrylic-urethane; wherein the resin is selected from the group consistent of acrylics, lacquers, alkyds, latex, polyurethane, phenolics, epoxies and waterborne; wherein the pigment dispersed resin has a reading of about 7 or greater on the Hagman gauge; wherein the pigment dispersed resin has reading of about 7 or greater on the Hagman gauge after 15 minutes of mixing; wherein the pigment dispersed resin has a reading of about 7 or greater on the Hagman gauge.

The method of claim 13, wherein the pigment dispersed resin has reading of about 7 or greater on the Hagman gauge after 15 minutes of mixing; wherein the pigment dispersed in the primary formation material has reading of about 7 or greater on the Hagman gauge after 15 minutes of mixing; wherein the coating is selected from the group consisting of an ink, an adhesive, and a paint; and wherein the coating is selected from the group consisting of an ink, an adhesive, and a paint.

Still additionally there is provided a method for making a black ceramic pigment, the method including: placing a polymer derived ceramic precursor on a forming surface, curing the polymer derived ceramic precursor on the forming surface, removing the cured polymer derived ceramic precursor from the forming surface, pyrolizing the cured polymer derived ceramic precursor, and thereby forming a black polymer derived ceramic pigment including from about 30 weight % to about 60 weight % silicon, from about 5 weight % to about 40 weight % oxygen, and from about 3 weight % to about 35 weight % carbon.

There is further provided the methods that have one or more of the following features: wherein 20 weight % to 80 weight % of the carbon is free carbon; wherein 20 weight % to 80 weight % of the carbon is silicon-bound-carbon; wherein the forming surface is moving; wherein the cured polymer derived ceramic is reduced in size by action of removal from the forming surface; wherein the pyrolized polymer derived ceramic is reduced in size to form a primary pigment particle; wherein the primary pigment particle has a particle size D₅₀ of less than about 4 μm; wherein the primary pigment particle has a particle size D₅₀ of from about 3 μm to about 0.1 μm; wherein the primary pigment particle has a particle size D₅₀ of from about 2 μm to about 0.5 μm; wherein the formulation is selected from the group consisting of paint, powder coat, adhesive, nail polish, and ink; wherein the pigment defines a blackness selected from the group consisting of: PMS 433, Black 3, Black 3, Black 4, Black 5, Black 6, Black 7, Black 2 2×, Black 3 2×, Black 4 2×, Black 5 2×, Black 6 2×, and Black 7 2×; wherein the pigment defines a blackness selected from the group consisting of: Tri-stimulus Colorimeter of X from about 0.05 to about 3.0, Y from about 0.05 to about 3.0, and Z from about 0.05 to about 3.0; a CIE L a b of L of less than about 40; a CIE L a b of L of less about 20; a CIE L a b of L of less than 50, b of less than 1.0 and a of less than 2; and a jetness value of at least about 200 M_{y}; wherein the coating defines a blackness selected from the group consisting of: PMS 433, Black 3, Black 3, Black 4, Black 5, Black 6, Black 7, Black 2 2×, Black 3 2×, Black 4 2×, Black 5 2×, Black 6 2×, and Black 7 2×; wherein the coating defines a blackness selected from the group consisting of: Tri-stimulus Colorimeter of X from about 0.05 to about 3.0, Y from about 0.05 to about 3.0, and Z from about 0.05 to about 3.0; a CIE L a b of L of less than about 40; a CIE L a b of L of less about 20; a CIE L a b of L of less than 50, b of less than 1.0 and a of less than 2; and a jetness value of at least about 200 M_{y}.

Still further there is provided a method of making a paint formulation including: combining a resin, a solvent, and a polymer derived ceramic pigment including from about 30 weight % to about 60 weight % silicon, from about 5 weight % to about 40 weight % oxygen, and from about 3 weight % to about 35 weight % carbon, and wherein 20 weight % to 80 weight % of the carbon is silicon-bound-carbon.

There is further provided the methods that have one or more of the following features: wherein the polymer derived ceramic pigment has a primary particle D₅₀ size of from about 0.1 μm to about 2.0 μm; wherein the polymer derived ceramic pigment is loaded at from about 1.5 pounds/gallon to about 10 pounds/gallon; wherein the resin is selected from the group of resins consisting of thermoplastic acrylic polyols, Bisphenol A diglycidal ether, silicone, oil based, and water-reducible acrylic; wherein the formulation has less than about 10 ppm of heavy metals; wherein the formulation has less than about 1 ppm of heavy metals; wherein the formulation has less than about 0.1 ppm of heavy metals; and wherein the coating includes a coating selected from the group consisting of industrial coatings, residential coatings, furnace coatings, engine component coatings, pipe coatings, and oil field coatings.

There is further provided the methods that have one or more of the following features: wherein the black polymer derived ceramic pigment includes about 40 weight % to about 50 weight % silicon, and wherein about 25 weight % to about 40 weight % of the carbon is silicon-bound-carbon; wherein the black polymer derived ceramic pigment includes about 40 weight % to about 50 weight % silicon, and wherein about 55 weight % to about 75 weight % of the carbon is free carbon; wherein the black polymer derived ceramic pigment includes about 20 weight % to about 30 weight % oxygen, and wherein about 25 weight % to about 40 weight % of the carbon is silicon-bound-carbon; wherein the black polymer derived ceramic pigment includes about 20 weight % to about 30 weight % oxygen, and wherein about 55 weight % to about 75 weight % of the carbon is free carbon; wherein the black polymer derived ceramic pigment includes about 20 weight % to about 30 weight % carbon, and wherein about 25 weight % to about 40 weight % of the carbon is silicon-bound-carbon; and wherein the black polymer derived ceramic pigment includes about 20 weight % to about 30 weight % carbon, and wherein about 55 weight % to about 75 weight % of the carbon is free carbon.

There is further provided the methods that have one or more of the following features: wherein the black polysilocarb derived ceramic pigment is hydrophilic and the primary material is aqueous; wherein the black polysilocarb derived ceramic pigment is hydrophilic and the primary material is aqueous; wherein the black polysilocarb derived ceramic pigment is rendered hydrophobic and the resin is non-aqueous.

### BRIEF DESCRIPTION OF THE DRAWINGS

FIG. 1 is a schematic flow diagram of an embodiment of a system in accordance with the present disclosures.

FIG. 2A is a scanning electron photomicrograph (SEPM) of an embodiment of a polysilocarb derived ceramic pigment. SEPM legend bar—HV 5.00 kV, WD 10.6 mm, magnification 5,000×, dwell 5 μs, spot 5.0, HFW 41.4 μm.

FIG. 2B is a SEPM of an embodiment of a polysilocarb derived ceramic pigment. SEPM legend bar—HV 5.00 kV, WD 10.6 mm, magnification 10,000×, dwell 5 μs, spot 5.0, HFW 20.7 μm.

### DESCRIPTION OF THE PREFERRED EMBODIMENTS

In general the present disclosures relate to ceramic black materials for use as, or in, colorants, inks, pigments, dyes, additives and formulations utilizing these black materials. Embodiments of the present disclosures, among other things, relate to ceramic materials having blackness, black color, and which are black; starting compositions for these ceramic materials, and methods of making these ceramic materials; and formulations, compositions, materials that utilize or have these ceramic materials. These various embodiments of the present disclosures, in particular, relate to, or utilize, such ceramic black materials that are polymer derived ceramics. Embodiments of the present disclosures also relate to black ceramics having silicon, oxygen and carbon, and methods of making these ceramics; formulations utilizing these black ceramics; and devices, structures and apparatus that have or utilize these formulations. Embodiments of the present disclosure in general include plastics, paints, inks, coatings, formulations, liquids and adhesives containing ceramic black materials, preferably polymer derived black ceramic materials, and more preferably polysilocarb polymer derived ceramic materials.

Polymer derived ceramics (PDC) are ceramic materials that are derived from, e.g., obtained by, the pyrolysis of polymeric materials. These materials are typically in a solid or semi-solid state that is obtained by curing an initial liquid polymeric precursor, e.g., PDC precursor, PDC precursor formulation, precursor batch, and precursor. The cured, but unpyrolized, polymer derived material can be referred to as a preform, a PDC preform, the cured material, and similar such terms. Polymer derived ceramics may be derived from many different kinds of precursor formulations, e.g., starting materials, starting formulations. PDCs may be made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O), to name a few.

A preferred PDC is “polysilocarb”, e.g., material containing silicon (Si), oxygen (O) and carbon (C). Polysilocarb materials may also contain other elements. Polysilocarb materials can be made from one or more polysilocarb precursor formulation or precursor formulation. The polysilocarb precursor formulations can contain, for example, one or more functionalized silicon polymers, other polymers, non-silicon based cross linking agents, monomers, as well as, potentially other ingredients, such as for example, inhibitors, catalysts, initiators, modifiers, dopants, fillers, reinforcers and combinations and variations of these and other materials and additives. Silicon oxycarbide materials, SiOC compositions, and similar such terms, unless specifically stated otherwise, refer to polysilocarb materials, and would include liquid materials, solid uncured materials, cured materials, and ceramic materials.

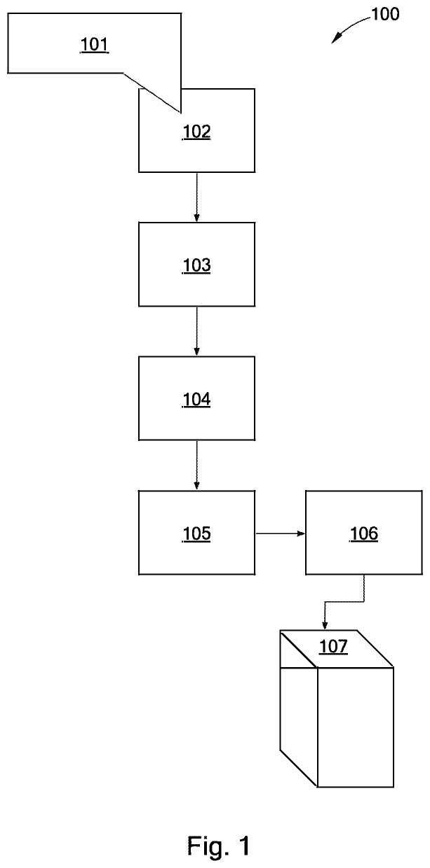

Turning to FIG. 1 there is provided a process flow chart 100 for an embodiment having several embodiments of the present processes and systems. Thus, there is a precursor make-up segment 101, where the PDC precursor formulations are prepared. There is a forming segment 102 where the PDC precursor is formed into a shape, e.g., bead, slab, and particle. There is a curing segment 103, where the PDC precursor is cured to a cured material, which is substantially solid, and preferably a solid. There is a pyrolysis segment 104 where the cured material is converted to a ceramic, e.g., a PDC, which preferably is a SiOC. There is a post-processing segment 105, where the ceramic is further processed, e.g., washing, grinding, agglomeration, milling, cycloning, sieving, etc. There is a formulation segment 106 where the PDC is processed into a material formulation (e.g., paint, plastic, ink, coating and adhesive), containing the PDC, i.e., a PDC containing material formulation. PDC containing material formulations include, among other things, PDC paints, PDC plastics, PDC inks, PDC adhesives, and PDC coatings. There is an application segment 107, where a PDC containing material formulation is applied to a substrate, e.g., a refrigerator, vehicle, appliance or other items, and components of such items.

By way of example, furnaces can that can be used for the pyrolizing segment include, among others: RF furnaces, Microwave furnaces, pressure furnaces, fluid bed furnaces, box furnaces, tube furnaces, crystal-growth furnaces, arc melt furnaces, induction furnaces, kilns, MoSi₂ heating element furnaces, gas-fired furnaces, carbon furnaces, and vacuum furnaces.

The post-processing segment can involve any type of further processing activities to enhance, effect, or modify the performance, handleability, processability, features, size, surface properties, and combinations and variations of these. Thus, for example, the post-processing step can involve a grinding step in which the PDC is reduced in size to diameters of less than about 10 μm, less than about 5 μm, less than about 1 μm, less than about 0.5 μm, and less than about 0.1 μm. The PDC can be ground, for example, by the use of a ball mill, an attrition mill, a rotor stator mill, a hammer mill, a jet-mill, a roller mill, a bead mill, a media mill, a grinder, a homogenizer, a two-plate mill, a dough mixer, and other types of grinding, milling and processing apparatus. The post-processing segment can involve, for example, an agglomeration, where smaller PDC particles are combined to form larger particles, preferably agglomerated particles having diameters of at least about 2 μm, at least about 2.5 μm, greater than 2.5 μm, at least about 3 μm, at least about 5 μm, at least about 10 μm, greater than 10 μm, and greater than 12 μm. Preferably, the agglomerated particles are sufficiently bound, or held together, to prevent the particles from falling off, e.g., separating from, the agglomeration during handling, shipping, storage, and processing, e.g., “handling strength.” More preferably, the strength of the agglomerations is only slightly greater than the handling strength, and in this manner can readily be broken apart into the smaller particles for use in a PDC material formulation. For example, the agglomeration can have a strength, e.g., crush strength, that is less than about 1/2000 of the strength of the smaller particles, e.g., primary particles, that form the agglomeration, less than about 1/500 of the strength of the smaller particles, less than about 1/75 of the strength of the smaller particles, and less than ½ of the strength of the smaller particles. The agglomeration can, for example, be formed by using spray drying techniques. Suitable binders, including for example sizing agents, for use in spray drying techniques include for example: dispersants, surfactants, soaps, copolymers, starches, natural and synthetic polymers and saccharides, lipids, fatty acids, petroleum-derived polymers and oligomers. Sodium alginate, corn starch, potato starch, and other naturally derived starches, fructoses, sucroses, dextroses and other naturally or synthetically derived saccharides and sugars, polylactic acid and other naturally derived polymers, cellulosic byproducts, carrageenan and other natural products, poly vinyl acetate and other water-soluble polymers, wetting and dispersing agents such as polyacrylates, polyethylene oxides, polypropylene oxides, and copolymers containing them. Parrafins and other waxes, other petrochemical derivatives and petroleum based polymers. Surfactants such as Tween, Span, Brij, and other types of surfactants; Stearates, oleates, and other modified oils; linear copolymers, branched copolymers, star polymers and copolymers, hyperbranched polymers and copolymers, comb-like polymers, and combinations and variations of these.

The amount of binder used to PDC can range from about 0.01% to 5%, about 0.1% to about 2%, and preferably less than about 1% and less than about 0.5%. Agglomerates can also be formed by batch evaporation and casting, thin film evaporation, wiped-film evaporation, tray drying, oven drying, freeze drying, and other suitable evaporation methods, aggregation techniques such as sedimentation, solvent exchange and coagulation, pin mixing, filtration, and others, preferably combined with a drying technique, and combinations and variations of these. Further, processing may involve the application of a surface treatment, wash, or coating to the surface of the PDC particles to provide predetermined features to the PDCs, such as for example, enhanced antistatic, wettability, material formulation compatibility, mixability, etc. It should be noted that while surface treatments are contemplated by the present disclosures to further enhance, e.g., specialize the PDC particles for a particular purpose; an advantage of the present disclosures is the feature that they are more readily mixed, added, or compiled into material formations, e.g., paints, plastics, inks, coating and adhesives, than the prior art black pigments, e.g., carbon black ((ASTM Color Index) CI Black 1, 6, 7) or graphite (CI Black 10) or metal oxides and mixed metal oxides, including but not limited to iron oxides (CI Black 11) and Manganese Iron oxide (CI Black 26) or Iron Manganese oxide (CI Black 33), Manganese oxide (CI Black 14), Copper oxide (CI Black 13), Copper Manganese Iron oxide (CI Black 26) or Copper Chrome oxide (CI Black 28), and pigment made by ashing organic matter (CI Black 8, 9) which typically for many applications require surface treatments. Thus, an advantage of the present disclosures, among other things, is the ability to use untreated PDC particles, e.g., no surface treatments, in materials formulation.

In the formulation segment, the making of the PDC material formulation takes place. Thus, for example, the PDC ceramic is mixed into, added to, or otherwise combined with the materials used to make up the material formulation. Generally, an agglomerate easily breaks down into its primary particles, e.g., the primary party state; and the primary particles are uniformly and smoothly distributed or suspended in the primary formulation material, which can be obtained in less than 60 minutes of mixing, less than 30 minutes of mixing and quicker. Typically, the PDC ceramic is much more easily mixed into the material formulation than carbon black to a fully dispersed state. For example, and by way of illustration, PDC ceramic can be easily and quickly mixed within 10 minutes into a vessel in which a simple 3 blade stirrer is mixing at 1,000 rpm tip speed. The resin, PDC Ceramic mixture will be fully dispersed which is illustrated by a reading of greater than 7 on the Hegman gauge. The Hegman gauge is a calibrated device to quickly show how fine a dispersion is made. A carbon black or oxide black pigment mixed into the resin in the same manner would produce a Hegman reading of less than 1 which indicates very large particles still in the resin, because these pigments require high energy milling to break up the aggregates in the ‘as supplied’ pigment. Generally, the PDC ceramic can be mixed into, added to, or otherwise combined with the material formulation in the same manner, using the same or existing equipment, that are present for use with other black pigments or colorants. Preferably, for many applications less expensive, quicker, more efficient equipment and much less expensive processes than are needed for carbon black can be used with the PDC particles.

In the application segment the PDC containing material formulation is applied to an end product, or a component that may be used in an end product. The PDC containing material formulation can typically, and preferably, be applied using the same types of techniques that are used for carbon black based formulations, e.g., brush, spray, dip, etc. Moreover, the PDC containing material formulations have applications, and the ability to be applied, in manners that could not be accomplished with a similar carbon black based formulation.

It should be understood that the various segments of the embodiment of FIG. 1 can be combined (e.g., a single piece of equipment could perform one of more of the operations of different segments, such as curing and pyrolizing), conducted serially, conducted in parallel, conducted multiple times, omitted (e.g., post-processing many not be necessary or required), conducted in a step wise or batch process (included where the segments are at different locations, separated by time, e.g., a few hours, a few days, months or longer, and both), conducted continuously, and in different orders and combinations and variations of these. Thus, for example the post-processing segment of grinding can be performed on the cured material prior to pyrolysis, and can also be performed on both the cured and pyrolized materials.

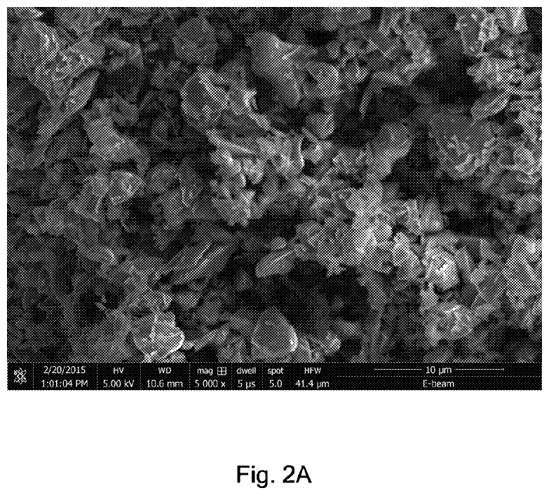

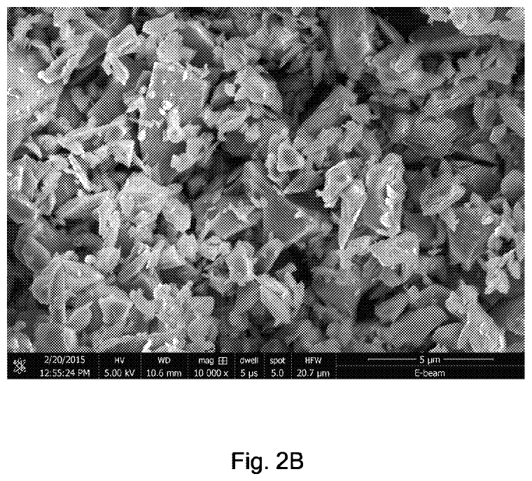

FIGS. 2A and 2B, are SEPMs of an embodiment of a polysilocarb derived ceramic pigment having a primary particle size of 3 μm D₅₀, that was made by curing and pyrolizing the polysilocarb precursor formulation into a monolithic block, and then breaking down that block into primary particles.

Black amorphous ceramic pigment made of SiOC (silicon oxycarbide) with hexamethyldisilazane (HMDZ). The HMDZ reacts with, or otherwise, complexes with Si—OH bonds (silanols) that can be present on the surface of the pigment. The HMDZ prevents these Si—OH groups from reacting with, or interacting with, materials in for example a paint formulation, other pigment particles or additives, or environmental conditions that a paint or coating containing the pigment is exposed to. The HMDZ treatment neutralizes any adverse effects of the silanols. The surface treatment will be accomplished with a 5% hexamethyldisilazane (HMDZ) solution in an organic solvent. The organic solvent could be any alkane, cyclic alkane, alkene, cyclic alkene or aromatic capable of solubilizing the treatment material. To extend this technology, we can also use this surface treatment method to provide functionality to the surface. In this vane, would could use any commercially available silane with at least one Si—OR (R=methyl, ethyl, propyl, iso-propyl, etc) that is hydrolysable. The functionality would include epoxy, amine, alkene, or alkane.

From 1% to 10 HMDZ solution, less than 10%, less than 5%, from about 0.5% to about 4%, from 1% to 2% and all values within these ranges, and well as higher concentrations can be used.

Silicon oxycarbide containing silica regions on the surface can be functionalized to provide extended functionalities or to block out potential reaction with the silanol groups on silica. Silanes of various functional groups, silazane and polysilazane, and silanol terminated silicone are most suitable for the treatment. The treating chemicals are selected depending upon the purpose of treatment.

To create inert surface silicon oxycarbide can be treated with silanes contain alkyl such as octyltrimethoxysilane, e.g., Silquest A-137 from Momentive, and silazane such as hexamethyldisilazane, octamethylcyclotetrasilazane and polysilazane.

To functionalize silicon oxycarbide to participate in addition polymerization, vinyl silane such as vinyl trialkoxysilane, e.g., Silquest A-151 and A-171 from Momentive, and (meth)acryl silane, e.g., Silquest A-174 from Momentive, can be used to react with the silanol on the SiOC.

To functionalize silicon oxycarbide to participate in epoxy reaction system, silanes containing amine, e.g., Silquest A-1100, A-1106, A-1110, A-1120, and A-1170 from Momentive, and epoxy silane, e.g., Silquest A-187 and A-186 from Momentive, can be used for the surface treatment.

To functionalize silicon oxycarbide to participate in urethane reaction system, silanes containing amine, silanes containing alcohol group, such as Momentive's Silquest A-1230, and silanes containing isocyanate, e.g., Silquest A-Link 25 and A-Link 35, can be used for the Example surface treatment.

The chemical treatment is carried out by condensation reaction between the silanol group of silicon oxycarbide with the alkoxysilane or silazane to generate —Si—O—Si—R to attach the functionality of R to the surface of silicon oxycarbide. Alcohol and ammonium are released as by products, respectively.

Depending upon the purpose of the treatment, the optimum level of treatment varies. To provide reactive group to participate in reactions, as low as one functionality per particle is sufficient. However, to passivate the silica surface, an amount sufficiently blocking reactive molecules from contacting free silanol must be used. In general, no more than 50% of silanol number is sufficient. For M-Tone 5100, silane of about 0.5% by weight of the pigment is sufficient.

### EXAMPLES

### Example 1. Surface Treatment with Hexamethyldisilazane (HMDZ)

In a glass kettle equipped with nitrogen inlet, overhead stirrer, and a condenser was charged 1079.2 g of xylene and 500.2 g of M-Tone 5199. The mixture was mixed under nitrogen until discrete particles were fully dispersed. While maintaining mixing and nitrogen blanket at ambient temperature, 25.1 g HMDZ was charged. Heat from exothermic reaction was detected. The batch was allowed to continue mixing for 3 hours at ambient and then heat then heat up to about 80° C. for 3 hours. The solvents were then removed by distillation to produce dry treated powder. While M-Tone 5100 is easily wetted and dispersed in water, the treated M-Tone particles became unwettable with water and float on surface of water.

### Example 2. Surface Treatment with Organofunctional Silanes

Gamma-glycidoxypropyltrimethoxysilane (Silquest A-187), gammaaminopropyltrimethoxysilane (Silquest A-1110) and hexamethyldisilazane were used in the treatment.

In a glass vial containing a magnetic stir was charged xylene, silane and M-Tone 5100 according to table 1 below. The mixture was mixed with a hot plate while mixing for 3 hours and the mixture was then heated to boil off the solvents to produce dry treated powder.

TABLE 1

| | | | |
|---|---|---|---|
| HMDZ | 0.2 | | |
| A-187 (eposxysilane) | | 0.24 | |
| A-1110 | | | 0.23 |
| (aminopropyltrimethoxysilane) | | | |
| Xylene | 9.8 | 9.8 | 9.8 |
| M-Tone 5100 | 2.01 | 2.12 | 2.01 |
| Total | 12.01 | 12.16 | 12.04 |
| % actives | 18% | 19% | 19% |
| Silane/M-Tone | 10% | 11% | 11% |

### Example 3. Surface Treatment with Polysilazane

In a glass jar was charged 65 g of xylene, 50 g of M-Tone 5100. The mixture was mixed with a cowl mixer to disperse the particles. While mixing, 5.3 g of Cerakote MC156 from NIC Industries, Inc. was slowly added. Exotherm was immediately detected. Upon completion of addition, the mixture was further mixed for another 15 minutes.

An aliquot of 10 g of the above sample was further mixed with 15.2 g of Cerakote MC156 to make a coating formula. While the untreated M-Tone 5100 was used in the coating formula soft gel particles were observed under microscope, the coating using the treated M-Tone was perfectly dispersed without agglomeration.

It is noted that there is no requirement to provide or address the theory underlying the novel and groundbreaking processes, materials, performance or other beneficial features and properties that are the subject of, or associated with, embodiments of the present disclosures. Nevertheless, various theories are provided in this specification to further advance the art in this area. These theories put forth in this specification, and unless expressly stated otherwise, in no way limit, restrict or narrow the scope of protection to be afforded the claimed disclosures. These theories many not be required or practiced to utilize the present disclosures. It is further understood that the present disclosures may lead to new, and heretofore unknown theories to explain the function-features of embodiments of the methods, articles, materials, devices and system of the present disclosures; and such later developed theories shall not limit the scope of protection afforded the present disclosures.

The various embodiments of formulations, batches, materials, compositions, devices, systems, apparatus, operations activities and methods set forth in this specification may be used in the various fields where pigments and additives find applicability, as well as, in other fields, where pigments, additives and both, have been unable to perform in a viable manner (either cost, performance or both). Additionally, these various embodiments set forth in this specification may be used with each other in different and various combinations. Thus, for example, the configurations provided in the various embodiments of this specification may be used with each other; and the scope of protection afforded the present disclosures should not be limited to a particular embodiment, configuration or arrangement that is set forth in a particular embodiment, example, or in an embodiment in a particular Figure.

The disclosure may be embodied in other forms than those specifically disclosed herein without departing from its spirit or essential characteristics. The described embodiments are to be considered in all respects only as illustrative and not restrictive.

What is claimed is:

1. A material comprising:
a pigment; and
one or more silicon oxycarbides (SiOC) disposed in the black ceramic pigment,
wherein a surface of the pigment is free of one or more silanols (Si—OH) bonds.

2. The material of claim 1, further comprising hexamethyldisilazane (HMDZ) at the surface of the pigment.
